(19) United States
(12) Patent Application Publication
(10) Pub. No.: US 2007/0150373 A1
(43) Pub. Date: Jun. 28, 2007

(54) System for delivering multi-temperature goods

(75) Inventor: Ju-Chia Kuo, Chu-Tung (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/637,772

(22) Filed: Dec. 13, 2006

(30) Foreign Application Priority Data
Dec. 23, 2005 (TW) 94146167

(51) Int. Cl. G06Q 30/00; G06Q 10/00

(52) U.S. Cl. 705/26; 705/28

(57) ABSTRACT

A system for delivering multi-temperature goods includes a goods distribution center, a goods collecting station, a plurality of customer ends, and a transport vehicle. The goods collecting station collects and temporarily stores goods of different storage temperatures to be dispatched for or delivered to customer ends. The transport vehicle conveys multi-temperature goods distributed by the distribution center to a goods collecting station in the neighborhood of a customer, or conveys multi-temperature goods from the goods collecting station to the distribution center.

### FIELD OF THE INVENTION

The present invention relates to a delivery system, and more particularly to a system for delivering multi-temperature goods.

### BACKGROUND OF THE INVENTION

In conventional goods delivery systems, foods having different storage temperatures are delivered mainly by specific vehicles. That is, a food to be kept at ambient temperature is delivered using a logistic vehicle providing a ambient temperature storage space, and a food to be kept at low temperature is delivered using a logistic vehicle providing a refrigerating or a freezing storage space. Due to limited number of trucks, depot, and distribution centers, the delivery system can only handle goods having a temperature within a specific range. Since it is impossible for the conventional goods delivery system to receive and deliver goods having temperatures outside the specific range, it brings a lot of confusions to customers who want to dispatch or receive goods via the delivery system. Moreover, it is inefficient and ineffective to deliver logistic articles using so many vehicles to provide different storage space requirements, particularly when there are so many different types of less than load articles to be delivered. With these difficulties, the investment and transit costs in the logistics business is largely increased.

Currently, many chained convenience stores and home-delivery logistic dealers provide the service of home-delivery of goods of different storage temperatures. Such foods of different storage temperatures are generally divided into only room-temp foods, refrigerating foods, and frozen foods. Moreover, the refrigerating foods and the frozen foods are transported using trucks equipped with large-scale refrigerator to provide a low-temp storage space. The refrigerator is frequently opened on the way of home delivery to adversely affect the constant low temperature in the refrigerator and accordingly the quality of the goods that must be delivered at a low temperature.

Another confusion that is frequently encountered in the conventional home delivery system is there might be no one at home to receive the delivered goods. Generally, customers have to wait at home for the home-delivery dealer's truck to dispatch or receive goods.

### SUMMARY OF THE INVENTION

A primary object of the present invention is to provide a system for delivering multi-temperature goods, so that foods of different storage temperatures may be collected or delivered at the same time, even if there are multiple types of goods in a small quantity each.

Another object of the present invention is to provide a system for delivering multi-temperature goods, in which goods collecting stations are set up to receive and temporarily store customer goods, so that customers may flexibly utilize the delivery system to dispatch or pick up goods.

To achieve the above and other objects, the system for delivering multi-temperature goods according to the present invention includes a goods distribution center, at least one goods collecting station, a plurality of customer ends, and at least one transport vehicle. The goods distribution center receives and distributes a plurality of goods with different storage temperatures; the at least one goods collecting station temporarily stores the plurality of goods; and the at least one transport vehicle carries a plurality of insulated logistic containers for holding goods of different storage temperatures. The transport vehicle is used to convey the goods distributed by the goods distribution center to the goods collecting station, and to convey the goods temporarily stored at the goods collecting station to the goods distribution center. The plurality of customer ends may independently receive goods delivered from the goods collecting station or dispatch goods through the goods collecting station.

The multi-temperature goods may include hot foods having a temperature higher than 60° C., ambient temperature foods, fresh foods kept at 18° C., cold foods kept at 0° C.˜+7° C., chilled foods kept at −2° C.˜+2° C., frozen foods and ice kept below −18° C., cryogenic foods kept below −30° C., and any combination thereof. By using a plurality of insulated logistic containers, the goods of different storage temperatures may be stored in different temperature environments under control without being frequently exposed to the open air, and carried by a ambient temperature transport vehicle to reduce transportation cost.

Depending on the goods of different storage temperatures, the insulated logistic containers may be flexibly provided with cold plates or heaters to maintain the containers at required storage temperatures. The insulated logistic container may be a complex insulated container to include a plurality of insulated compartments of different storage temperatures at the same time.

The goods collecting station may be, for example, a community administration center, a chained convenience store, or a hypermarket, or be set up in the neighborhood of the customer ends. And, the transport vehicle may include a pickup and delivery truck, a distribution truck, or a transfer vehicle.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual view of a system for delivering multi-temperature goods according to a first embodiment of the present invention;

FIG. 2 is a conceptual view of a system for delivering multi-temperature goods according to a second embodiment of the present invention;

FIG. 3 is a flowchart showing the delivery sequences according to the delivery system of the present invention;

FIG. 4 shows a multi-temperature insulated container used in the delivery system of the present invention;

FIG. 5 shows a cold (heat) storage box used in the delivery system of the present invention;

FIG. 6 shows a cold (heat) storage cabinet used in the delivery system of the present invention;

FIG. 7 shows the cold (heat) storage box of FIG. 5 having cold plates provided therein;

FIG. 8 shows the cold (heat) storage cabinet of FIG. 6 having cold plates provided therein;

FIG. 9 shows a freezer used in the delivery system of the present invention;

FIG. 10 shows a ambient temperature truck used in the delivery system of the present invention;

FIG. 11 shows a distribution truck used in the delivery system of the present invention; and

FIG. 12 shows a transfer vehicle used in the delivery system of the present invention.

### DETAILED DESCRIPTION OF THE PREFERRED EMBODIMENTS

The present invention discloses a system and method for delivering multi-temperature goods in a more efficient and highly sanitary manner. The delivery system of the present invention is particularly suitable for handling multi-temperature goods, such as foods of different storage temperatures, and allows distribution of the multi-temperature goods at the same time via the same delivery channel.

The system for delivering multi-temperature goods according to the present invention includes at least one goods distribution center, at least one goods collecting station, a plurality of customer ends, and at least one transport vehicle. The goods distribution center receives and distributes a plurality of goods having different storage temperatures. The goods collecting stations temporarily store a plurality of goods of different storage temperatures. The transport vehicles carry and deliver a plurality of insulated logistic containers, in which various goods of different storage temperatures are received. The transport vehicles transport goods of different storage temperatures distributed by the goods distribution center to different goods collecting stations, and transport goods of different storage temperatures temporarily stored in the goods collecting stations to the goods distribution center. The customer ends receive goods of different storage temperatures delivered to customer house by the goods collecting stations, or dispatch goods of different storage temperatures through the goods collecting stations. The goods collecting station may be, for example, a community administration center, a chained convenience store, a hypermarket, or a customer house. When a goods collecting station collects goods from a customer for dispatch, the collected goods is then transferred to a business branch, at where the collected goods is recorded and primarily handled, and then delivered to the distribution center by a transport vehicle, such as a distribution truck. All the collected goods are sorted at the distribution center and then conveyed by distribution trucks to depot in the neighborhood of customer houses. Goods sent to the depot are further delivered using pickup and delivery trucks to goods collecting stations, at where the delivered goods are temporarily stored until they are picked up by customers. Of course, customers may also utilize the same delivery channel to dispatch goods to a specified customer.

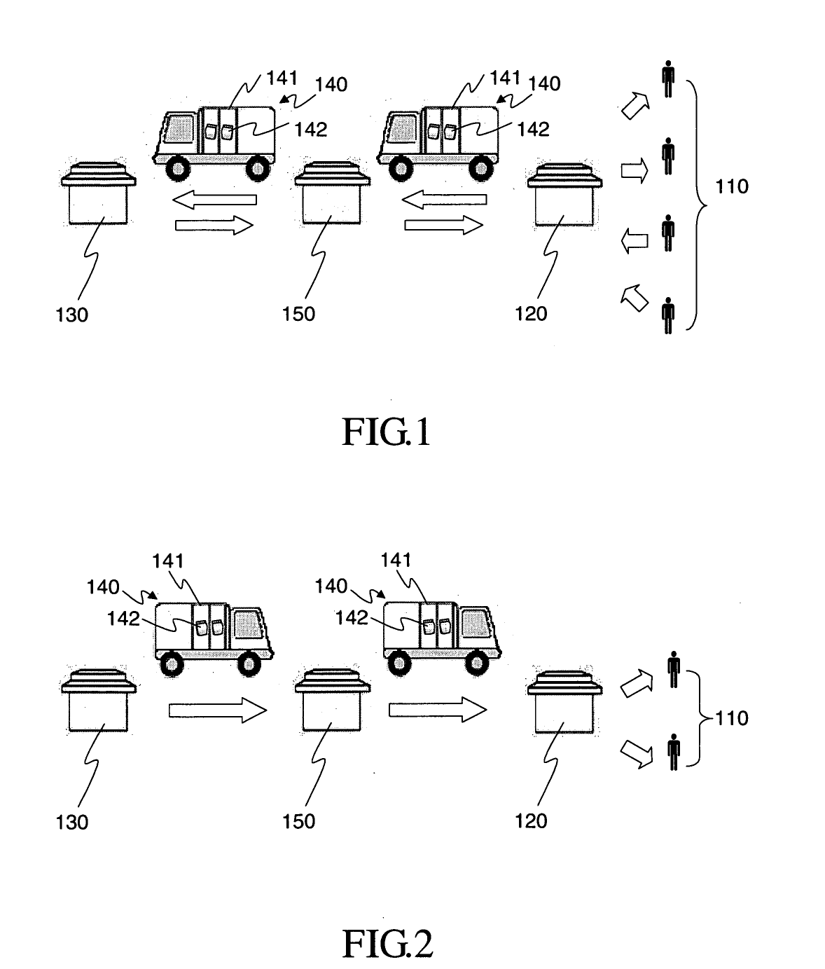

The customer end may receive or dispatch multi-temperature goods through the goods collecting station. The customer end may be a general family. The depot form a link between the goods distribution center and the goods collecting stations. The depot may be set up according to different districts for sorting, recording, and receiving multi-temperature goods from goods collecting stations. FIG. 1 is a conceptual view of a delivery system according to a first embodiment of the present invention. As shown, in the first embodiment, the delivery system of the present invention includes a customer end 110, a goods collecting station 120, a distribution center 130, and a transport vehicle 140. The transport vehicle 140 is loaded with at least one insulated logistic container 141 for holding goods 142 having a specific storage temperature provided by the customer end 110. In the first embodiment of the present invention, goods 142 of specific storage temperature provided by the customer end 110 is first sent to the good collecting station 120 and then positioned in a suitable insulated logistic container 141. The insulated logistic container 141 is then conveyed by the transport vehicle 140 to a business branch 150, at where the goods 142 is recorded and sorted and then transported by the transport vehicle 140 to the goods distribution center 130. The goods 142 of specific storage temperatures positioned in the insulated logistic containers 141 is then transported by the transport vehicle 140 from the goods distribution center 130 to a business branch 150, from where the goods are further delivered to a good collecting station 120. The customer end 110 specified as receiver may go to the goods collecting station 120 to pick up the delivered goods 142 at any time.

The present invention may also provide the service of delivering related goods. FIG. 2 is conceptual view of a delivery system according to a second embodiment of the present invention. As shown, in the second embodiment, the delivery system of the present invention includes a customer end 110, a goods collecting station 120, a distribution center 130, and a transport vehicle 140. The transport vehicle 140 is loaded with at least one insulated logistic container 141. In the second embodiment, the goods distribution center 130 receives an order placed by the customer end 110, and goods 142 of a specific storage temperature specified in the order is then positioned in insulated logistic container 141 and conveyed by the transport vehicle 140 from the goods distribution center 130 to a business branch 150, from where the goods 142 is further delivered to a goods collecting station 120 using the transport vehicle 140. Customer end 110 placing the order may then go to the goods collecting station 120 to pick up the ordered goods 142 at any time without the need of particularly waiting at home for the home-delivery.

The goods 142 of different storage temperatures may include hot foods having a temperature higher than 60° C., ambient temperature (ambient temperature) foods, fresh foods kept at 18° C., refrigerated foods kept at −2° C.˜+7° C., chilled foods kept at −2° C.˜+2° C., frozen foods and ice kept below −18° C., and ultra-chilled foods kept below −30° C., and any combination thereof. Since the number of the insulated logistic containers used in the present invention may be flexibly adjusted, it is possible to provide the service of delivering multiple types of goods of different storage temperatures in a small quantity each. Moreover, the business branch and the goods distribution center function to collect, record, and sort different types of goods of different storage temperatures, so that multi-temperature goods to be delivered to the same district may be delivered at the same time.

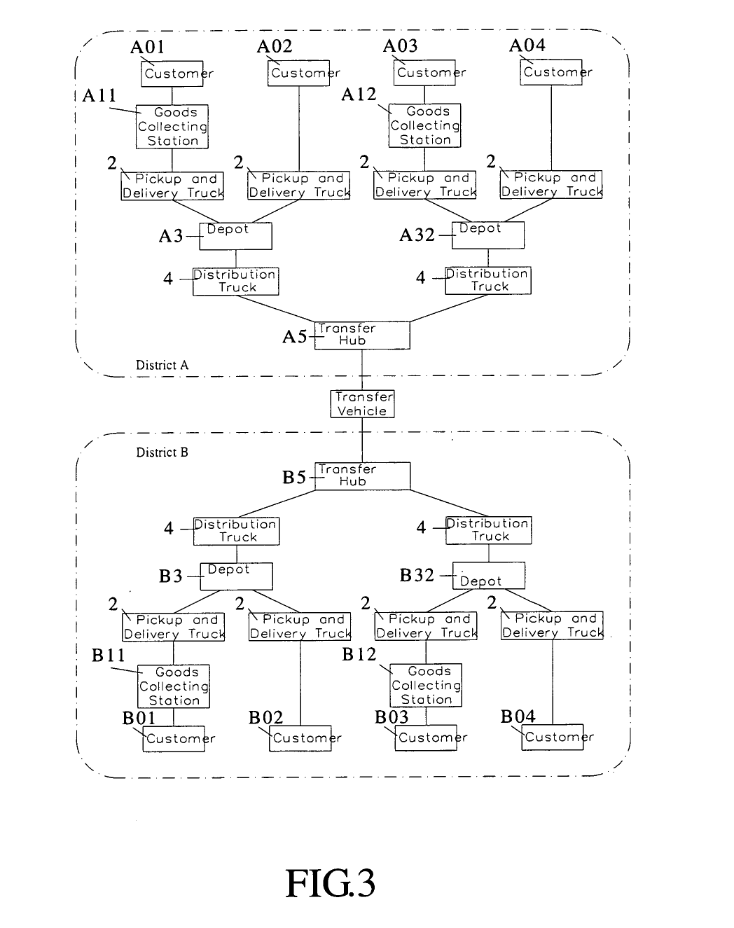

FIG. 3 is a flowchart showing the delivery sequences according to the delivery system of the present invention. As shown, the delivery system of the present invention may operate in more than one district, such as in a first district A and a second district B. In the first district A, there are included a plurality of customers A01, A02, A03, and A04; a plurality of goods collecting stations A11 and A12; a plurality of pickup and delivery trucks 2; a plurality of depot A3 and A32; a plurality of distribution trucks 4; and a transfer hub A5. And, in the second district B, there are included a plurality of customers B01, B02, B03, and B04; a plurality of goods collecting stations B11 and B12; a plurality of pickup and delivery trucks 2; a plurality of depot B3 and B32; a plurality of distribution trucks 4; and a transfer hub B5. Moreover, the transfer hub A5 in the first district A and the transfer hub B5 in the second district B are linked through a transfer vehicle 6.

When a customer A01 in the district A wants to send goods to another customer A03 in the same district A, a pickup and delivery truck 2 is assigned to collect the goods consigned by the customer A01 at a goods collecting station A11 in the neighborhood of the customer A01. The goods collecting station A11 may be, for example, a community administration center, a chained convenience store, a hypermarket, or even the customer's house. Then, the pickup and delivery truck 2 conveys the collected goods to the business branch A3. The consigned goods is recorded and primarily handled at the business branch A3, and then transferred by a distribution truck 4 to the transfer hub A5, at where the consigned goods is sorted and then conveyed by a distribution truck 4 to the business branch A32 in the neighborhood of the customer A03. The consigned goods is then delivered by a pickup and delivery truck 2 to the goods collecting station A12 and temporarily stored thereat. The customer A03 may go to pick up the goods at the goods collecting station A12 at his or her convenience. Of course, the customer A03 may also utilize the same channel to dispatch goods to the customer A01.

Alternatively, with a customer A02 who can wait at home for the pickup and delivery truck 2, it is not necessary for the customer to send the consigned goods to the goods collecting station A11. A pickup and delivery truck 2 may directly go to the customer A02 to pick up the consigned goods, and utilizes the above-described channel to deliver the consigned goods to the customer A03. And, with a customer A04 who can wait at home for receiving goods delivered to home, goods consigned by either the customer A01 who cannot wait at home for the pickup and delivery truck 2 or the customer A02 who can wait at home for the pickup and delivery truck 2 could be delivered through the above-described delivery channel to the customer A04 without the need of sending the consigned goods to the goods collecting station A12.

Similarly, customers B01 and B03 in the district B may utilize the goods delivery channel in the district B to dispatch goods. When the customer A01 in the district A wants to send goods to the customer B01 in the district B, a pickup and delivery truck 2 is assigned to collect the goods consigned by the customer A01 at the goods collecting station A11 and deliver the consigned goods to the business branch A3, at where the consigned goods is recorded and then conveyed by a distribution truck 4 to the transfer hub A5. Since the consigned goods is to be sent to another district, it is further transported by a transfer vehicle 6 from the transfer hub A5 to the transfer hub B5, at where the consigned goods is sorted and then conveyed by a distribution truck 4 to a business branch B3 in the neighborhood of the customer B01. The consigned goods is then delivered by a pickup and delivery truck 2 from the business branch B3 to a goods collecting station B11 and temporarily stored thereat. The customer B01 may go the goods collecting station B11 to pick up the consigned goods at his or her convenience.

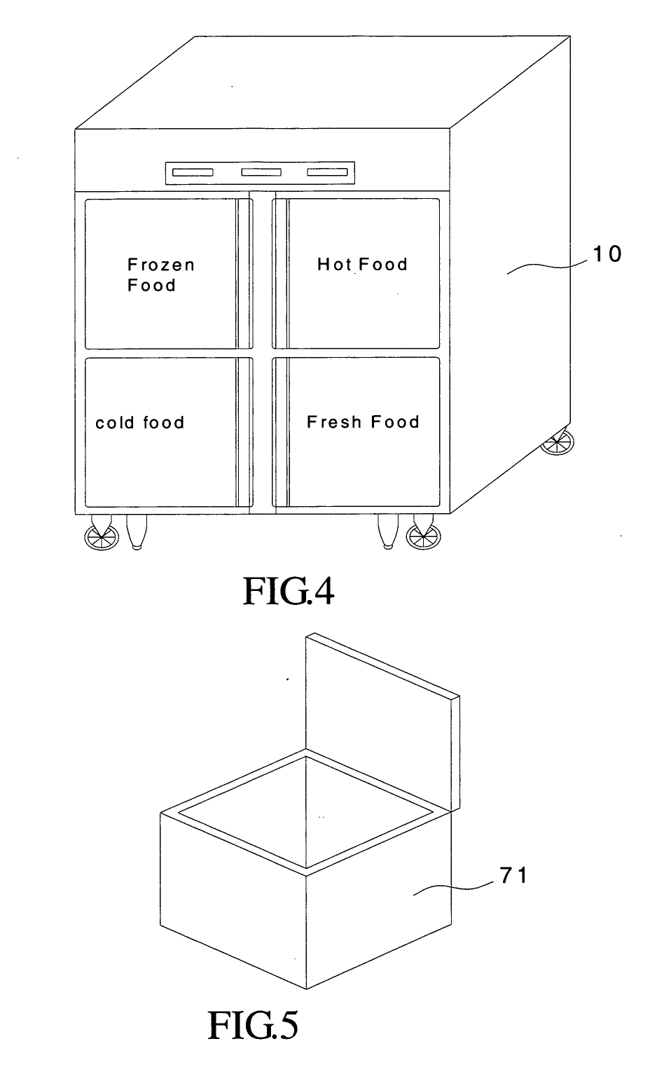

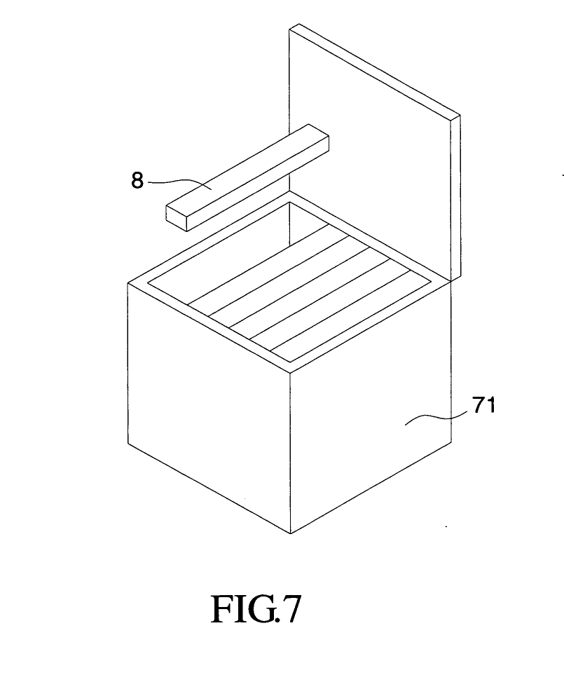

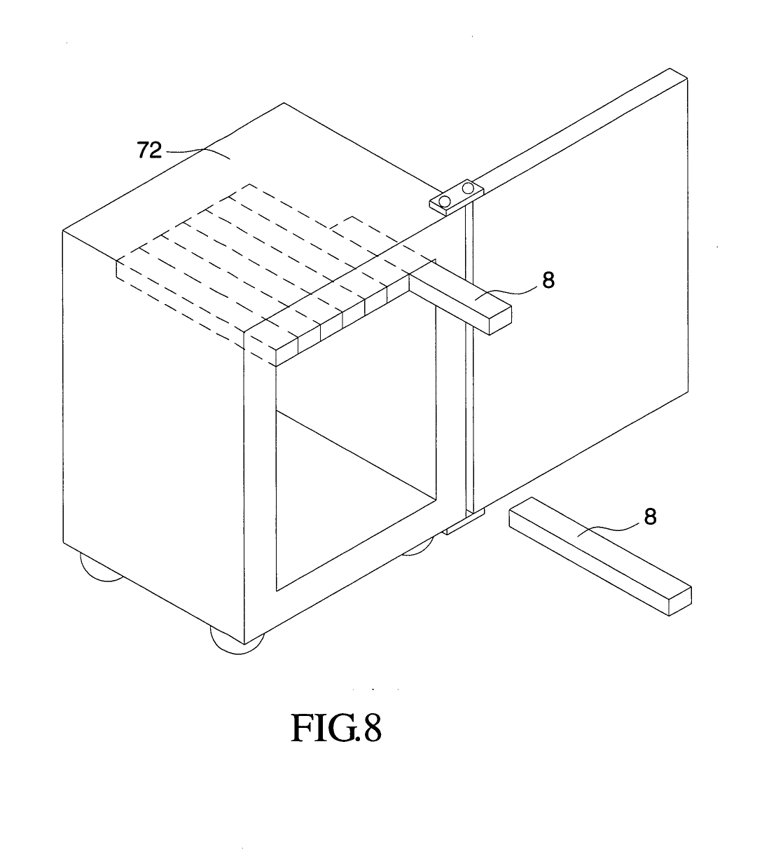

The goods collecting stations A11, A12, B11, and B12 included in the delivery system of the present invention are equipped with a plurality of multi-temperature insulated containers 10 shown in FIG. 4, so as to temporarily store various consigned goods of different storage temperatures. With the goods collecting stations equipped with multi-temperature insulated containers 10, it is not necessary for a customer to wait at home for a pickup and delivery truck 2 to collect the consigned goods. The goods collecting station may be set up at, for example, a community administration center, a chained convenience store, a hypermarket, or even a gateway of the customer house. The multi-temperature insulated containers 10 is divided into several insulated compartments, to which cold or heat energy is separately supplied from a freezer to control different low or high temperature in the insulated compartments. Alternatively, cold or heat accumulators 8 may be provided in the insulated containers 10 to separately supply cold or heat energy. FIGS. 7 and 8 show a cold/heat storage box 71 and a cold/heat storage cabinet 72, respectively, in which cold or heat accumulators 8 are provided.

With the above arrangements, customers A01, A02, A03, A04 and customers B01, B02, B03, B04 may dispatch goods by utilizing the delivery channels in the districts A and B. The delivery channel systems in the districts A and B may be expanded, reduced, or reproduced depending on an actual size of the districts.

The depot and the transfer hub in each district are set up mainly to collect, record, and sort various kinds of consigned goods, so that goods to be collected in or delivered to the same district could be centralized and handled. The centralized collection and delivery of consigned goods via the depot and transfer hubs has the following advantages:
1. The space and procedures for handling consigned goods can be flexibly set up.
2. The whole delivery system does not require high cost at the early stage of investment, and may be flexibly expanded without difficulties.
3. The operation and management of the whole delivery system is simple but effective.

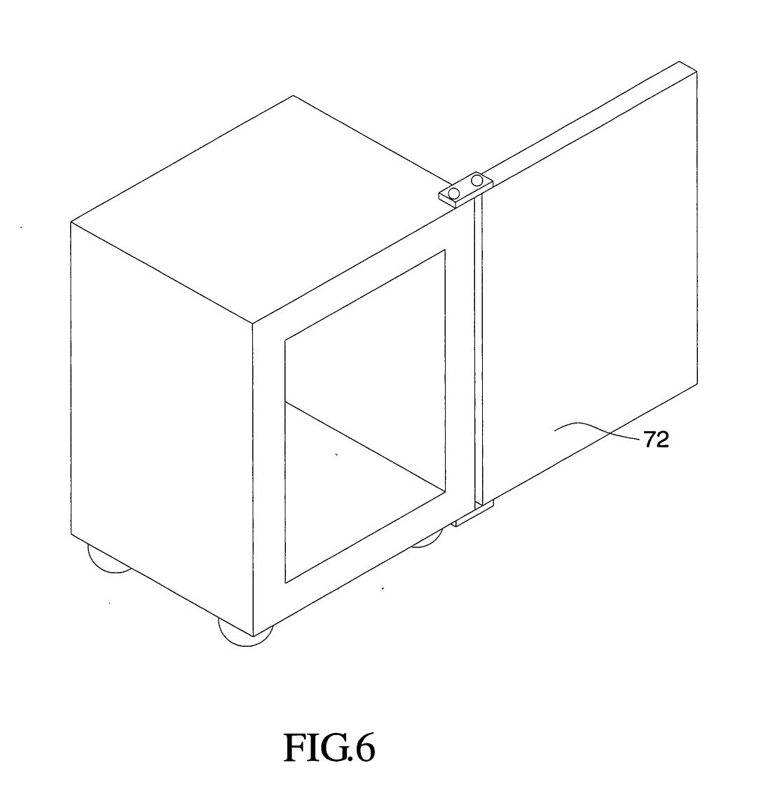

To achieve the object of collecting multi-temperature goods at the same time, the delivery system of the present invention is equipped with not only wheeled multilayer containers 7 for ambient temperature goods (see FIG. 11), but also cold/heat storage boxes 71 (see FIG. 5) and cold/heat storage cabinets 72 (see FIG. 6) for holding various types of goods of different storage temperatures. The cold/heat storage boxes 71 have a fixed volume and are mainly used on a pickup and delivery truck 2 for holding low-temp goods consigned by the same one customer. The cold/heat storage cabinets 72 are mainly used on a distribution truck 4 and a transfer vehicle 6 for holding a large quantity of low-temp goods for long-distance transportation. With the cold/heat storage boxes 71 and the cold/heat storage cabinets 72, room-temp trucks may be used to convey goods of any storage temperatures, including low-temp and hot foods.

Please refer to FIGS. 7 and 8. The cold/heat storage box 71 and the cold/heat storage cabinet 72 may be internally provided with a plurality of cold/heat accumulators 8. Cold/heat accumulators 8 of different temperatures may be distinguished using different colors. By using different quantities of cold/heat accumulators 8 of different temperatures, it is possible to provide storage environments of different temperature levels in the cold/heat storage box 71 and the cold/heat storage cabinet 72 for storing low-temp and hot foods, while the required temperature levels may be maintained for at least a predetermined time. Since the cold/heat accumulator 8 does not include any power for refrigerating or freezing, it does not produce any noise and waste gas.

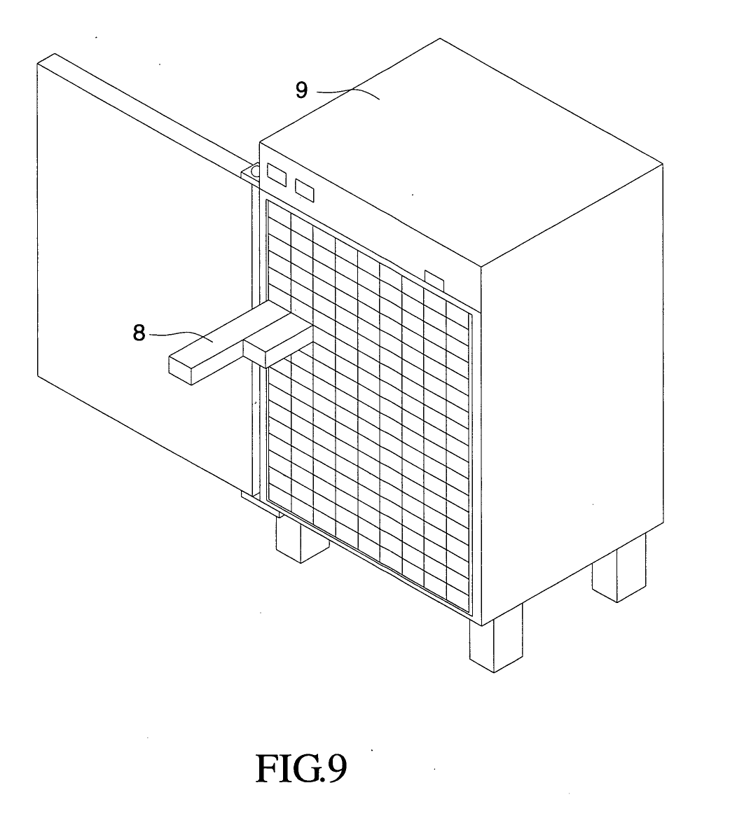

FIG. 9 shows a refreezing freezer 9 commonly provided at the depot and the transfer hub in each district. The refreezing freezer 9 may store and re-freeze a large quantity of cold plates 8 therein at any time, so that there are sufficient cold plates 8 for supplying to the pickup and delivery trucks 2, the distribution trucks 4, and the transfer vehicles 6.

The depot and the transfer hub in each district are also provided with heaters or hot water for storing and re-heating a large quantity of heat accumulators 8 at any time, so that there are sufficient heat accumulators 8 for supplying to the pickup and delivery trucks 2, the distribution trucks 4, and the transfer vehicles 6.

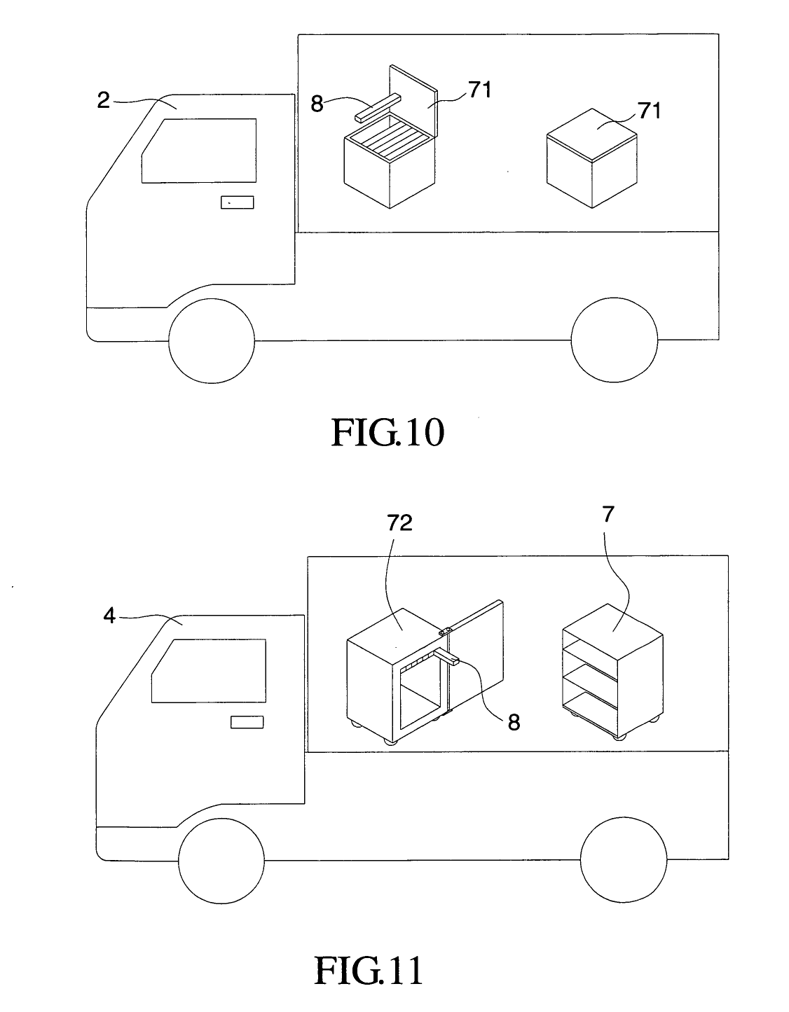

FIG. 10 shows a pickup and delivery truck 2 that is a room-temp truck adapted for carrying a plurality of cold/heat storage boxes 71. The number of the cold/heat storage boxes 71 may be flexibly decided depending on different types of goods to be collected or delivered. Cold/heat accumulators 8 of different temperatures are used in the cold/heat storage boxes 71 to create storage environments of different temperature levels for low-temp and hot foods, so that multi-temperature goods may be collected and delivered at the same. The pickup and delivery truck 2 used in the delivery system of the present invention has the following advantages:
1. The pickup and delivery truck 2 provides high mobility in collecting and delivering goods, and is a room-temp truck that is not so expensive.
2. The pickup and delivery truck 2 may be equipped with cold/heat storage boxes 71 depending on the quantity of goods to be handled, so as to provide flexible low-temp storage space thereon.
3. Storage environments of different temperature levels suitable for low-temp and hot foods may be flexibly created by using cold/heat accumulators 8 of different temperatures, so as to ensure the quality and cleanness of delivered goods.
4. Multi-temperature goods may be collected and delivered at the same time to decrease the times of collecting and delivering goods and thereby lower the conveyance cost.
5. The cold/heat storage boxes 71 may be designed to have different volumes, and be selected for use depending on the size of goods and the available space on the truck.

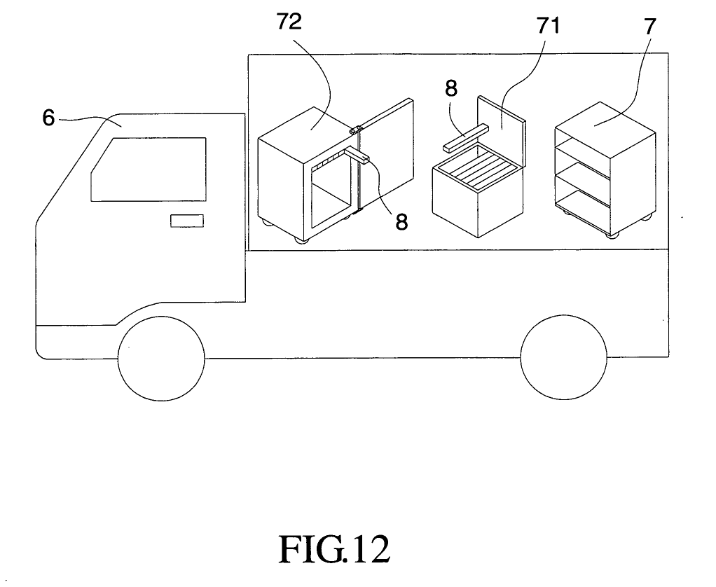

FIGS. 11 and 12 show a distribution truck 4 and a transfer vehicle 6, respectively, adapted for carrying a plurality of wheeled multilayer containers 7 and cold/heat storage cabinets 72. The distribution truck 4 is used mainly to convey goods between the depot and the transfer hub in the same district, and the transfer vehicle 6 is used mainly to transport goods between two distantly apart transfer hubs in two different districts. The distribution truck 4 and the transfer vehicle 6 have the following advantages:
1. The trucks 4 and 6 may be room-temp trucks for carrying and long-distance transporting a large quantity of goods of different storage temperatures, including various low-temp and hot foods.
2. The trucks 4 and 6 may be equipped with cold/heat storage boxes 72 depending on the quantity of goods to be handled, so as to flexibly provide storage space thereon for goods of any storage temperature, including low-temp and hot foods.
3. Storage environments of different temperature levels suitable for low-temp and hot foods may be flexibly created by using cold/heat accumulators 8 of different temperatures in the cold/heat storage cabinets 72, so as to ensure the quality and cleanness of delivered goods.
4. Multi-temperature goods may be distributed and transferred at the same time to decrease the times of transport to lower the transportation cost.
5. The trucks 4 and 6 are not necessary a professional freezer car or insulated truck to thereby reduce the transportation cost.

In brief, the numbers and the operating temperatures of the wheeled multilayer containers 7, the cold/heat storage boxed 71, and the cold/heat storage cabinets 72 carried by the pickup and delivery truck 2 and the distribution truck 4 may flexibly changed depending on the types and quantities of consigned goods to be collected or delivered. This provides the following advantages:
1. Since the trucks 2 and 4 may be used to collect and deliver goods of different types and storage temperatures at the same time, they fully meet the requirements in practical business field.
2. The trucks 2 and 4 enable conveyance of multiple types of goods with a small quantity each, and therefore provide high mobility to reduce times and cost of transportation.
3. Foods can be timely delivered to customers in a fresh state.
4. All the pickup and delivery trucks 2, the distribution trucks 4, and the transfer vehicles 6 may be room-temp trucks, and the modularized wheeled multilayer containers 7, the cold/heat storage boxes and cabinets 71, 72 having the advantages of providing flexible function, easy to handle, energy-saving, and upgrading home-delivery efficiency.
5. Since the cold/heat accumulators 8 create storage environments of different temperature levels in the cold/heat storage boxes and cabinets 71, 72 for goods of different storage temperatures, it is not necessary to use professional low-temp or insulated vehicles. The goods can be delivered to customers within shortened time at reduced labor and transportation costs.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A system for delivering multi-temperature goods, comprising:
a goods distribution center for receiving and distributing a plurality of goods of different storage temperatures;
at least one goods collecting station for temporarily storing the plurality of goods;
a plurality of customer ends, who independently receive goods delivered from the goods collecting station or dispatch goods via the goods collecting station; and
at least one transport vehicle for carrying a plurality of insulated logistic containers for holding goods of different storage temperatures; said transport vehicle being used to convey the goods distributed by the goods distribution center to the goods collecting station, and to convey the goods temporarily stored at the goods collecting station to the goods distribution center.

2. The system for delivering multi-temperature goods as claimed in claim 1, wherein the customer ends are general families.

3. The system for delivering multi-temperature goods as claimed in claim 1, wherein the goods collecting station is selected from the group consisting of a community administration center, a chained convenience store, and a hypermarket.

4. The system for delivering multi-temperature goods as claimed in claim 1, wherein the goods collecting station is located at a place in the neighborhood of the customer ends.

5. The system for delivering multi-temperature goods as claimed in claim 1, wherein each of the insulated logistic containers includes a plurality of insulated compartments having different temperatures.

6. The system for delivering multi-temperature goods as claimed in claim 1, wherein each of the insulated logistic containers is internally provided with one or more cold/heat accumulators to produce different temperatures in the container.

7. The system for delivering multi-temperature goods as claimed in claim 1, wherein each of the insulated logistic containers is internally provided with more than one heater.

8. The system for delivering multi-temperature goods as claimed in claim 1, wherein the transport vehicle is selected from the group consisting of a pickup and delivery truck, a distribution truck, and a transfer vehicle.

9. The system for delivering multi-temperature goods as claimed in claim 8, wherein the transport vehicle is a room-temp truck.

10. The system for delivering multi-temperature goods as claimed in claim 8, wherein the goods with different storage temperatures include hot foods having a temperature higher than 60° C., ambient temperature (ambient temperature) foods, fresh foods kept at 18° C., refrigerated foods kept at −2° C.˜+7° C., chilled foods kept at −2° C.˜+2° C., frozen foods and ice kept below −18° C., ultra low temperature foods kept below −30° C., and any combination thereof.

11. The system for delivering multi-temperature goods as claimed in claim 1, further comprising at least one business branch for recording and sorting the goods of different storage temperatures.

12. The system for delivering multi-temperature goods as claimed in claim 1, wherein the goods distribution center receives orders placed by the customer ends, and the goods of different storage temperatures are specified in the orders.

13. A system for delivering multi-temperature goods, comprising:
a first district having at least one customer and provided with at least one goods collecting station, at least one pickup and delivery truck, at least one business branch, at least one distribution truck, and at least one transfer hub;
a second district having at least one customer and provided with at least one goods collecting station, at least one pickup and delivery truck, at least one business branch, at least one distribution truck, and at least one transfer hub; and the transfer hub of the second district being linked with the transfer hub of the first district through a transfer vehicle; and
the goods collecting station in the first district receiving goods consigned by a first customer in the first district for sending to a second customer, the pickup and delivery truck collecting the consigned goods from the goods collecting station and conveying the collected goods to the business branch, from where the consigned goods being conveyed by the distribution truck to the transfer hub; the consigned goods being then conveyed by another distribution truck from the transfer hub to a business branch in the neighborhood of the second customer, and further delivered by another pickup and delivery truck from the business branch to a goods collecting station, at where the consigned goods being picked up by the second customer.

14. The system for delivering multi-temperature goods as claimed in claim 13, wherein the goods collecting station is selected from the group consisting of a community administration center, a chained convenience store, a hypermarket, and a customer house.

15. The system for delivering multi-temperature goods as claimed in claim 13, wherein customers in the second district also utilize the delivery channel in the second district to dispatch goods from one to another.

16. The system for delivering multi-temperature goods as claimed in claim 13, further comprising a multi-temperature insulated container for storing various goods of different storage temperatures.

17. The system for delivering multi-temperature goods as claimed in claim 13, further comprising a wheeled multilayer container equipped with cold/heat storage boxes and cold/heat storage cabinets.

18. The system for delivering multi-temperature goods as claimed in claim 17, wherein the cold/heat storage cabinets are used on the distribution truck and the transfer vehicle.

19. The system for delivering multi-temperature goods as claimed in claim 17, wherein the cold/heat storage boxes and cold/heat storage cabinets of different temperatures are distinguished using different colors.

20. The system for delivering multi-temperature goods as claimed in claim 13, further comprising a re-freezing freezer equipped at each of the transfer hubs.
